(19) United States
(12) Patent Application Publication
(10) Pub. No.: US 2014/0067502 A1
(43) Pub. Date: Mar. 6, 2014

(54) METHOD AND APPARATUS FOR PROVISIONING A PRICE-DIFFERENTIATED PRODUCT WHILE DETERRING PIRACY

(71) Applicants: Sanjeev Kumar Biswas, Bangalore (IN); Kiran Kumar, Santa Clara, CA (US); Suraj Ranjan, Noida (IN); Mayank Goyal, Noida (IN); Anubhav Malhotra, New Delhi (IN); Pritom Baruah, Sunnyvale, CA (US)

(72) Inventors: Sanjeev Kumar Biswas, Bangalore (IN); Kiran Kumar, Santa Clara, CA (US); Suraj Ranjan, Noida (IN); Mayank Goyal, Noida (IN); Anubhav Malhotra, New Delhi (IN); Pritom Baruah, Sunnyvale, CA (US)

(73) Assignee: Adobe Systems Inc., San Jose, CA (US)

(21) Appl. No.: 13/599,561

(22) Filed: Aug. 30, 2012

(51) Int. Cl. G06Q 30/02; G06Q 30/06

(52) U.S. Cl. 705/14.23

(57) ABSTRACT

A method and apparatus for provisioning price-differentiated products while deterring piracy comprising creating a plurality of triples, wherein each triple comprises a first component, a second component, and a third component, wherein each triple uniquely identifies a price-differentiated product; providing to a vendor of the product a plurality of pairs, wherein each pair in the plurality of pairs comprises the first component and the second component of the triple for each price-differentiated product provided to the vendor; receiving the pair from the vendor when the product is sold; providing to a purchaser identification verifier the pair for the product that was sold; receiving from the purchaser identification verifier the second component of the triple upon verification of an identity of a purchaser; and providing product activation information to the identity verified purchaser in response to receiving the second component, wherein the activation information enables use of the product.

### BACKGROUND OF THE INVENTION

1. Field of the Invention

Embodiments of the present invention generally relate to software anti-piracy techniques and, more particularly, to a method and apparatus for provisioning a price-differentiated product while deterring piracy.

2. Description of the Related Art

Software providers often use differential pricing in order to provide software products to special groups at discounted prices. For example, Adobe Systems, Incorporated of San Jose, Calif. offers ADOBE® PHOTOSHOP® to academia, via a Student and Teacher edition (STE), at a lower price than the standard edition of ADOBE® PHOTOSHOP®. Software piracy is a problem for software providers of STEs and other products with a price differential. An unauthorized purchaser may buy a large quantity of STEs at the lower price and sell them at higher prices. As a result, software firms are losing a significant amount of profits, where a significant portion of the loss is attributed to the abuse of the STEs.

Currently, validation of a price-differentiated product purchaser is performed at the time of sale. For example, in the case of a student purchasing an STE, the student may be required to display a student identification card and provide a valid student email address, for example, and email address with a .edu suffix. However, performing the validation at the time of purchase involves increased purchase time and is cumbersome for the vendor as well as the purchaser. An alternate solution is to provide the purchaser with a special store for price-differentiated products. However, having a specialized store is costly and requires a dedicated setup.

Therefore, there is a need in the art for a method and apparatus for provisioning a price-differentiated product while deterring piracy.

### SUMMARY

Embodiments of the invention relate to a method and apparatus for provisioning a price-differentiated product while deterring piracy. The method and apparatus create a plurality of triples, wherein each triple comprises a first component, a second component, and a third component, wherein each triple uniquely identifies a price-differentiated product. The method and apparatus provide to a vendor of the product a plurality of pairs wherein each pair in the plurality of pairs comprises the first component of the triple and the second component of the triple for each price-differentiated product provided to the vendor. The method and apparatus receive the pair from the vendor when the product is sold and provide the pair to a purchaser identification verifier. The method and apparatus receive from the purchaser identification verifier the second component of the triple upon verification of an identity of a purchaser; and provide product activation information to the identity verified purchaser in response to receiving the second component, wherein the activation information enables use of the price-differentiated product.

### BRIEF DESCRIPTION OF THE DRAWINGS

FIG. 1 depicts a block diagram of a system for provisioning price-differentiated products while preventing software piracy, according to one or more embodiments;

FIG. 2 depicts a flow diagram of a method for registering a purchase of a software product, as performed by the sales notification module of FIG. 1, according to one or more embodiments;

FIG. 3 depicts a flow diagram of a method for provisioning a price-differentiated product while deterring piracy, as performed by the product coordination module and the redemption code validation module of FIG. 1, according to one or more embodiments;

FIG. 4 depicts a flow diagram of a method for validating a redemption code, as performed by the redemption code validation module of FIG. 1, according to one or more embodiments;

FIG. 5 depicts a flow diagram of a method for activating the purchased subscription product as performed by the activation module of FIG. 1, according to one or more embodiments; and

FIG. 6 depicts a computer system that can be utilized in various embodiments of the present invention, according to one or more embodiments.

While the method and apparatus is described herein by way of example for several embodiments and illustrative drawings, those skilled in the art will recognize that method and apparatus for provisioning price-differentiated products while deterring piracy is not limited to the embodiments or drawings described. It should be understood, that the drawings and detailed description thereto are not intended to limit embodiments to the particular form disclosed. Rather, the intention is to cover all modifications, equivalents and alternatives falling within the spirit and scope of method and apparatus for provisioning price-differentiated products while deterring piracy as defined by the appended claims. Any headings used herein are for organizational purposes only and are not meant to limit the scope of the description or the claims. As used herein, the word “may” is used in a permissive sense (i.e., meaning having the potential to), rather than the mandatory sense (i.e., meaning must). Similarly, the words “include”, “including”, and “includes” mean including, but not limited to. Additionally, the term “software product” is intended to include a hardware product that is activated, accessed or operable using a software portion of the hardware product. The term “purchaser” is intended to include types of users who are entitled to access/use of the software product, such as a renter, employee, or other entitled entity. The term “sold” is intended to include forms of action that result in the “purchaser” having access/use to the software product, such as employee access rights, that is, where there is no “purchase” by the one seeking access/use.

### DETAILED DESCRIPTION

Embodiments of the present invention comprise a method and apparatus for provisioning price-differentiated products while deterring piracy. When a price-differentiated product is sold, the purchaser is given a vendor identification number (VIN) and a universal resource locator (URL) of an identity verification website. The user must navigate to the URL, enter the VIN, and provide information requested at the identity verification website. Upon successful verification that the purchaser is a member of a population for which the price-differentiated product is intended, a redemption code is displayed to the purchaser, or in some embodiments, sent directly to a redemption server. If displayed to the purchaser, the purchaser then navigates to the redemption server that validates the redemption code and provides the user with a serial number that the purchaser can use to activate the price-differentiated product on the purchaser's computer.

Exemplary embodiments of the present disclosure herein refer to Student/Teacher Edition (STE) software products; however, those skilled in the art will appreciate the invention as applied to any price-differentiated products, including hardware products that are activated or operable using software. A price-differentiated product may be sold as a time-limited product or as a perpetual product. A subscription product is one example of a time-limited product where a purchaser is provided access to the product for a set period of time (term). At the end of the term, the subscription may be renewed to allow the purchaser continued access to the subscription product. If the subscription is not renewed, then access to the subscription product is terminated. If the product is a perpetual product, the purchaser is granted access to the product for an unlimited period of time (with no termination).

Before a software product is provided for sale by a vendor, a software provider may store information related to the product in a database. For example, the database may contain vendor identification numbers (VINs), redemption codes, and serial numbers for a given product. A VIN, a redemption code, and a serial number, herein referred to as a “triple” are associated with one another and uniquely identify a software product available for purchase. A triple provides all of the information for a software product. For example, the VIN identifies a specific product and whether the product has been sold, the redemption code identifies whether the product has been redeemed, and the serial number identifies whether the product is a subscription product or a perpetual product. When a software product is provided to a vendor for sale, a list of VIN, redemption code pairs (taken from the triples) is stored on the vendor's server with a state of the VIN initialized to UNSOLD.

When a software product is purchased, the purchaser may receive a box with software media containing the product and a VIN. When the purchase is complete, the vendor retrieves the VIN, redemption code pair for the purchased product and updates the state of the VIN to SOLD. The vendor sends a list containing VIN, redemption code pairs for all purchased products to the third party identity verification server. The vendor also sends the list of pairs to a redemption server, where the redemption server updates the VIN in the associated triple to SOLD in the triples database on the redemption server.

The purchaser navigates to the third party identity verification server and enters the VIN that was included with the software product at the time of purchase. The third party identity verification server accesses the VIN, redemption code pair list received from the vendor server to ensure the VIN is on the list and marked as sold. The third party identity verification server validates the identity of the purchaser. The third party identity verification server uses various identity verification methods known in the art to verify the purchaser is a member of the group for which the price-differentiated product is intended. For example, if the price-differentiated product is an STE, the third party identity verification server may use a database of universities that contains valid email ids and photographs from school ids for each student and teacher. The purchaser must provide enough information to satisfy the third party identity verification server. If the purchaser is successfully validated, the third party identity verification server sends the redemption code from the VIN, redemption code pair to the client.

The purchaser navigates to the redemption server and logs in if the purchaser has an account, and if not, creates an account on the redemption server. The purchaser account information is stored in a user profile. The purchaser then enters the redemption code on the redemption server. The VIN, redemption code, serial number triple is retrieved from a triples database. The method validates the redemption code and determines what type of software product was purchased (i.e., subscription or perpetual). A property of the serial number identifies whether the purchased software product is a subscription product or a perpetual product. If the purchased product is a perpetual product, the serial number is sent to the client and displayed to the purchaser. The purchaser may load the media onto the client and use the serial number to activate the product. If the purchased product is a subscription product, the subscription terms are stored in the user profile and the serial number and additional product information is returned to the client computer, where the subscription software is activated.

Some portions of the detailed description which follow are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and is generally, considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

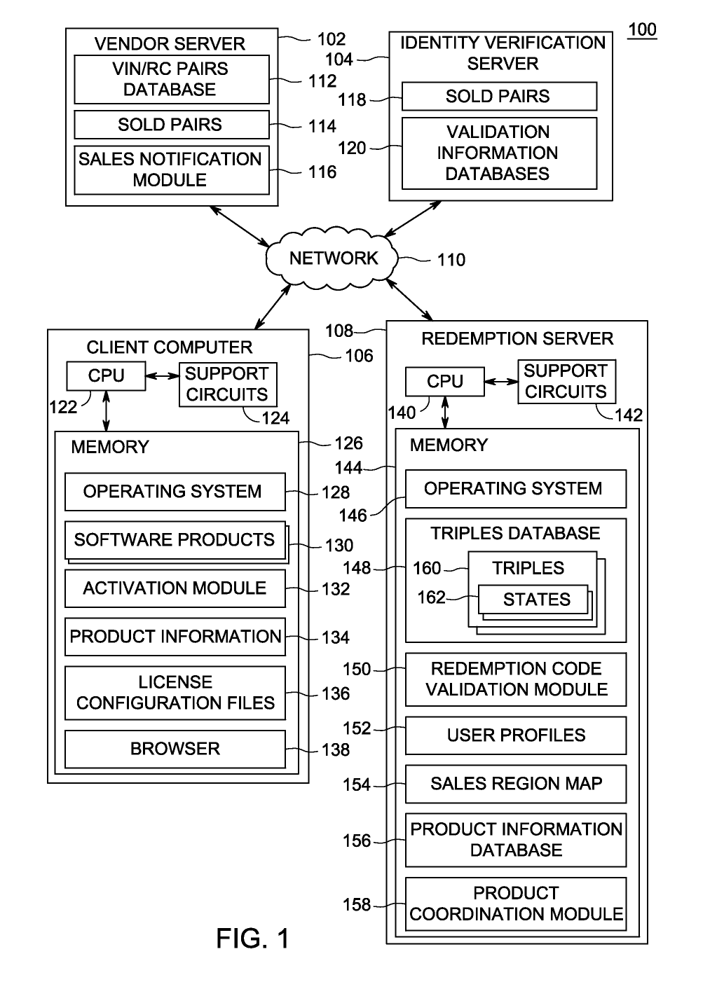

FIG. 1 depicts a block diagram of a system 100 for provisioning price-differentiated products while preventing software piracy, according to one or more embodiments. The system 100 comprises a vendor server 102, an identity verification server 104, a client computer 106, and a redemption server 108, communicatively coupled via a network 110. The identity verification server 104 and the redemption server 108 may be separate servers, as shown, or may be combined into a single server.

The vendor server 102 comprises a database of VIN/redemption code (RC) pairs, a list of sold pairs 114, and a sales notification module 116.

The identity verification server 104 is a third party identity verification service, such as IDENTITY CHEK®, ExpectID®, and the like. The identity verification server 104 verifies the purchaser of a price-differentiated product as a member of the population for which the price-differentiated product is intended. The identity verification server 104 receives a file of sold pairs 118 from the vendor server 102 that contains a list of VIN/RC pairs that were sold by the vendor. The identity verification server 104 comprises validation information databases 120 that contain information required to verify the identity of a purchaser.

The client computer 106 comprises a CPU 122, support circuits 124, and a memory 126. The CPU 122 may comprise one or more commercially available microprocessors or microcontrollers that facilitate data processing and storage. The various support circuits 124 facilitate the operation of the CPU 122 and include one or more clock circuits, power supplies, cache, input/output circuits, displays, and the like. The memory 126 comprises at least one of Read Only Memory (ROM), Random Access Memory (RAM), disk drive storage, optical storage, removable storage and/or the like. The memory 126 comprises an operating system 128, software products 130, an activation module 132, product information 134, license configuration files 136, and a browser 138.

The operating system 128 generally manages various computer resources (e.g., network resources, file processors, and/or the like). The operating system 128 is configured to execute operations on one or more hardware and/or software modules, such as Network Interface Cards (NICs), hard disks, virtualization layers, firewalls and/or the like. Examples of the operating system 128 may include, but are not limited to, Linux, Mac OSX, BSD, Unix, Microsoft Windows, and the like.

According to some embodiments, the browser 138 is operated by the purchaser to login to the redemption server 108 and the identity verification server 104. Examples of a browser 138 may include, but are not limited to, Firefox, Google Chrome, Internet Explorer, Opera, and Safari, Android browser, Firefox for mobile, Internet Explorer Mobile, among others.

The redemption server 108 validates a redemption code and returns a serial number to the client computer 106 that is used by the purchaser to activate the price-differentiated product on the client computer 106. The redemption server 108 comprises a CPU 140, Support Circuits 142, and a memory 144. The CPU 140 may comprise one or more commercially available microprocessors or microcontrollers that facilitate data processing and storage. The various support circuits 142 facilitate the operation of the CPU 140 and include one or more clock circuits, power supplies, cache, input/output circuits, displays, and the like. The memory 144 comprises at least one of Read Only Memory (ROM), Random Access Memory (RAM), disk drive storage, optical storage, removable storage and/or the like. The memory 144 comprises an operating system 146, a product coordination module 158, a triples database 148, a redemption code validation module 150, user profiles 152, a sales region map 154, and a product information database 156. The triples database 148 comprises a plurality of triples 160. Each triple 160 comprises a plurality of states 162.

The operating system 146 generally manages various computer resources (e.g., network resources, file processors, and/or the like). The operating system 146 is configured to execute operations on one or more hardware and/or software modules, such as Network Interface Cards (NICs), hard disks, virtualization layers, firewalls and/or the like. Examples of the operating system 146 may include, but are not limited to, Linux, Mac OSX, BSD, Unix, Microsoft Windows, and the like.

Before a software product is provided for sale, the product coordination module 158 creates a database of information related to the software product in a triples database 148. For example, the database may contain vendor identification numbers (VINs), redemption codes, and serial numbers for a given product. A VIN, a redemption code, and a serial number, herein referred to as a “triple” are associated with one another and identify a software product available for purchase. A triple 160 provides all of the information for a software product. For example, the VIN identifies a specific product and whether the product has been sold, the redemption code identifies whether the product has been redeemed, and the serial number identifies whether the product is a subscription product or a perpetual product. When a software product is provided to a vendor for sale, the product coordination module 158 provides a list of VIN, redemption code pairs (taken from the triples 160) that are stored in a VIN/RC pairs database 112 on the vendor's server 102 with a state 162 of the VIN initialized to UNSOLD.

When a software product 130 is purchased, the purchaser may receive a box with software media containing the product and a VIN. When the purchase is complete, the sales notification module 116 on the vendor server 102 retrieves the VIN, redemption code pair for the purchased product and updates the state 162 of the VIN to SOLD. The sales notification module 116 may send the list of sold pairs 114 containing VIN/RC pairs for all sold products to the third party identity verification server 104. The sales notification module 116 also sends the list of sold pairs 114 to the redemption server 108. The product coordination module 158 updates a state 162 of the VIN in the associated triple 160 to SOLD in the triples database 148 on the redemption server 108.

The purchaser navigates via the browser 138 on the client computer 106 to the third party identity verification server 104 and enters the VIN on the third party identity verification server 104 that was included with the software product 130 at the time of purchase. The third party identity verification server 104 accesses the list of VIN/RC pairs 118 received from the vendor server to ensure the VIN is on the sold pairs 118. The third party identity verification server 104 validates the identity of the purchaser. The third party identity verification server 104 uses various identity verification methods known in the art to verify the purchaser is a member of a population for which the price-differentiated product is intended. For example, if the price-differentiated product is a Student/Teacher Edition (STE), the third party identity verification server 104 may use a validation information database 120 of universities that contains valid email ids and photographs from school ids for each student and teacher. The purchaser must provide enough information to satisfy the third party identity verification server 104. In some embodiments, if the purchaser is successfully validated, the third party identity verification server 104 sends the redemption code from the VIN/RC pair to the client computer 106.

In other embodiments, the purchaser navigates via the browser 138 to the redemption server 108 and logs in if the purchaser has an account, and if not, creates an account on the redemption server 108. The purchaser's account information is stored in a profile 152. The purchaser then enters the redemption code on the redemption server 108. The VIN, redemption code, serial number triple 160 is retrieved from the triples database 148. The redemption code validation module 150 validates the redemption code. In some embodiments, as part of the validation process, a country code in the user profile 152 is compared to the sales region (found in the VIN) where the product was purchased. The country code in the user profile 152 must be mapped to the sales region where the product was purchased in the sales region map 154. If the redemption code validation is successful, the redemption code validation module 150 determines what type of software product was purchased (i.e., subscription or perpetual). A property of the serial number identifies whether the purchased software product 130 is a subscription product or a perpetual product. If the purchased product is a perpetual product, the serial number is sent to the client computer 106 and displayed to the purchaser via the browser 138. The purchaser may load the media received in the box at the time of purchase onto the client computer 106 and use the serial number to activate the software product 130.

If the purchased product is a subscription product, the subscription terms are stored in the user profile 152. Additional product data is retrieved from the product information database 156 and the product data and the serial number are sent to the client computer 106. A product ID in the product data is an index into product information 134. The product information 134 contains a reference to a license configuration file 136 that is to be used to load a license onto the client computer 106 in order to activate the software product 130. If any license already exists on the client computer 106 for the serial number, the old license is deleted and the new license is loaded and activated. The purchaser may then use the software product 130.

In some embodiments, when the identity verification server 104 validates the purchaser, the identity verification server 104 sends the redemption code directly to the redemption server 108, where processing proceeds as described above on the redemption server 108, thereby removing the necessity for the purchaser to receive the redemption code from the identity verification server 104 and re-enter it on the redemption server 108.

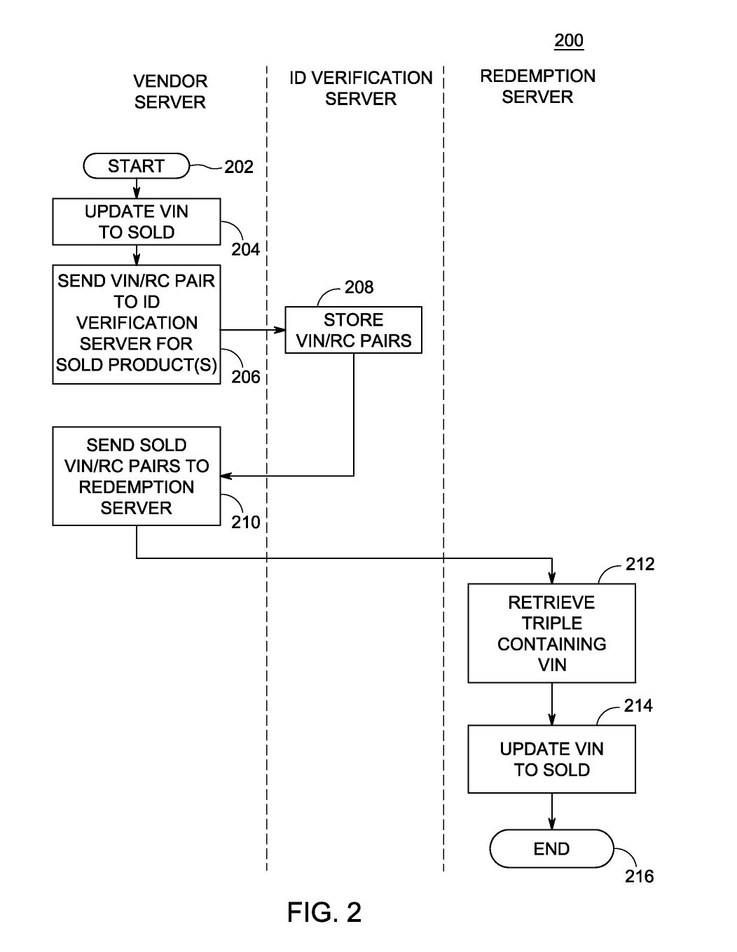

FIG. 2 depicts a flow diagram of a method 200 for registering a purchase of a software product, as performed by the sales notification module 116 of FIG. 1, according to one or more embodiments. The method 200 modifies an entry in a database to indicate a product has been SOLD and transmits the information about the sold product to various servers for later use.

The method 200 starts at step 202 and proceeds to step 204. At step 204, the method 200 updates a VIN for a purchased product. The method 200 accesses a list of VIN/redemption code (RC) pairs database. A state (or status indicator) in the VIN was initialized to “UNSOLD”. The method 200 updates the state of the VIN to “SOLD”. The method 200 proceeds to step 206, where the method 200 facilitates sending the sold VIN/RC pair to an identity verification server. The method 200 proceeds to step 208, where the method 200 stores the VIN/RC pair in a file of sold pairs on the identity verification server. The identity verification server uses the VIN/RC pair in a validation process as described below. The method 200 proceeds to step 210, where the method 200 facilitates sending the sold VIN/RC pair from the vendor server to a redemption server. The method 200 proceeds to step 212, where the method 200 uses the VIN/RC pair as an index into a triples database to retrieve an associated VIN/RC/serial number triple for the sold product. The method 200 proceeds to step 214, where the method 200 updates the state of the VIN in the triple to “SOLD”. The method 200 then saves the updated triple in the triples database. The method 200 proceeds to step 216 and ends.

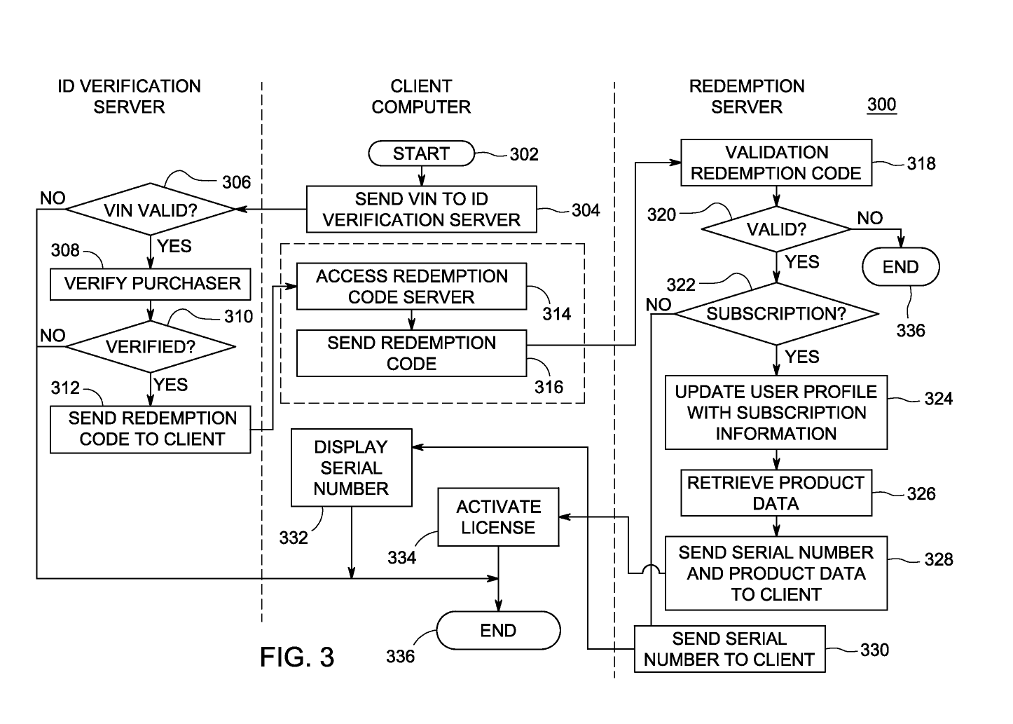

FIG. 3 depicts a flow diagram of a method 300 for provisioning a price-differentiated product while deterring piracy, as performed by the product coordination module 158 and the redemption code validation module 150 of FIG. 1, according to one or more embodiments. The method 300 facilitates verifying a purchaser is a member of a population entitled to the price-differentiated product. Once the purchaser is verified, the method 300 returns a redemption code to the client computer, which is sent to a redemption server for validation. Once the redemption code is validated, the method 300 sends a serial number, and possibly other product information, to a client computer that enables the utilization of the software product.

The method 300 starts at step 302 and proceeds to step 304. At step 304, the method 300 facilitates sending a VIN from the client computer to an identity verification server. The VIN is entered by a purchaser via a browser on a client computer. In some embodiments, the identity verification server is a third-party service provider. The identity verification server receives a list of VIN/RC pairs of products from vendors, via, for example a vendor server, when a product is sold. The VIN entered by the purchaser must be included in the list already stored at the identity verification server in order for the purchaser to be verified.

The method 300 proceeds to step 306, where the method 300 determines whether the VIN is valid. The method 300 uses the VIN as an index into the VIN/RC pairs list. If the VIN is not found in the list, the method 300 proceeds to step 336 and ends. However, if the VIN is found in the list, the method 300 proceeds to step 308, where the method 300 verifies the purchaser. In order to purchase a price-differentiated product, a purchaser must be a member of the population for which the price differential was intended. For example, if the price-differentiated product is a Student/Teacher edition (STE), the method 300 verifies that the purchaser is a student or a teacher. If the price-differentiated product is, for example, intended for senior citizens, the method 300 verifies the purchaser is a senior citizen. The method 300 verifies the proceeds to step 310, where the method 300 determines whether the identity of the purchaser was verified. If the method 300 determined the purchaser was not verified, meaning the purchaser could not provide information to prove they are a member of the intended population, the method 300 proceeds to step 336 and ends. However, if the purchaser was successfully verified, the method 300 facilitates sending the price differentiated redemption code from the VIN/RC pair to the client computer.

The method 300 proceeds to step 314, where the method 300 facilitates allowing a purchaser access to the redemption code server. When a purchaser accesses the redemption code server, the purchaser must login using the purchaser's userID that is associated with the purchaser's user profile stored at the redemption code server. If the purchaser does not have a userID, the purchaser is required to create a userID and a user profile. The method 300 proceeds to step 316, where the method 300 facilitates sending the redemption code received from the identity verification server to the redemption server. In some embodiments, steps 314 and 316 may be omitted. In such embodiments, the method 300, at step 312, facilitates sending the price differentiated redemption code from the VIN/RC pair from the identity verification server directly to the redemption server.

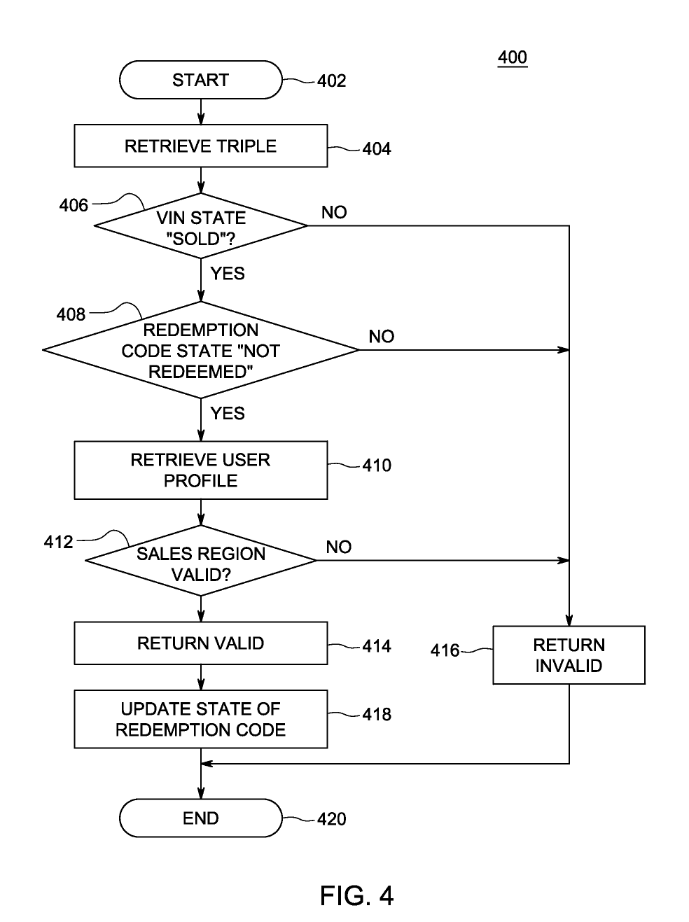

The method 300 proceeds to step 318, where the method 300 validates the redemption code as described in further detail with respect to FIG. 4. The method 300 proceeds to step 320 where the method 300 determines whether the redemption code is valid. If the method 300 determines the redemption code is invalid, the method 300 proceeds to step 336 and ends. However, if the method 300 determines the redemption code is valid, the method 300 proceeds to step 322.

At step 322, the method 300 determines whether the purchased software product is a subscription product or a perpetual product. A subscription product is one in which a purchaser is provided access to product for a set period of time (term). At the end of the term, the subscription may be renewed to allow the purchaser continued access to the subscription product. If the subscription is not renewed, then access to the subscription product is terminated. If the product is a perpetual product, the purchaser is granted access to the product for an unlimited period of time (with no termination). When the redemption code was validated in step 318, a triple that provides information about the purchased product was retrieved from a triples database. The triple contains a serial number for the purchased software product 130. The serial number identifies whether the purchased product is a subscription product or a perpetual product. If the identified product is a perpetual product, the method 300 proceeds to step 330, where the method 300 facilitates sending the serial number to the client computer and the method 300 proceeds to step 332. At step 332, the method 300 displays the serial number that was received from the redemption server. A purchaser may load their software media onto the client computer and use the serial number to activate the software. The method 300 proceeds to step 336 and ends.

However, if at step 322, the method 300 determines the purchased product is a subscription product, the method 300 proceeds to step 324, where the method 300 updates the purchaser's user profile with subscription information. The method 300 creates an array that defines terms of a subscription and various other details regarding the subscription product and stores the array in the purchaser's user profile. If a purchaser already has an existing subscription for the purchased subscription product, and is purchasing an upgrade of a subscription product, the array in the purchaser's user profile for the existing subscription is updated with the product subscription information for the product upgrade.

The method 300 proceeds to step 326, where the method 300 retrieves product data for the purchased subscription product. The product data includes a product ID that is used to activate the subscription product on the client computer.

Dominance information is also retrieved. When a user profile contains more than one subscription for a product, dominance information defines which product subscription is dominant, meaning which subscription encompasses more subscription products. For example, ADOBE® CREATIVE SUITE® Master Collection contains ADOBE® PHOTOSHOP®, ADOBE® ILLUSTRATOR®, ADOBE® INDESIGN®, ADOBE® ACROBAT®, ADOBE® DREAMWEAVER®, and many more subscription products. Suppose, for example, ADOBE® CREATIVE SUITE® Design Standard contains ADOBE® PHOTOSHOP®, ADOBE® ILLUSTRATOR®, ADOBE® INDESIGN®, and ADOBE® ACROBAT®. The subscription product that encompasses more products, in the present example, ADOBE® CREATIVE SUITE® Master Collection, dominates a product containing fewer products, namely ADOBE® CREATIVE SUITE® Design Standard. The retrieved dominance information from the scenario table determines what products are licensed for the purchaser. In the present example, defining ADOBE® CREATIVE SUITE® Master Collection as the dominant subscription entitles the purchaser to activate a license for all subscription products under the ADOBE® CREATIVE SUITE® Master Collection. However, if ADOBE® CREATIVE SUITE® Design Standard were defined as the dominant subscription, the purchaser would be entitled to activate a license for the products ADOBE® PHOTOSHOP®, ADOBE® ILLUSTRATOR®, ADOBE® INDESIGN®, and ADOBE® ACROBAT®.

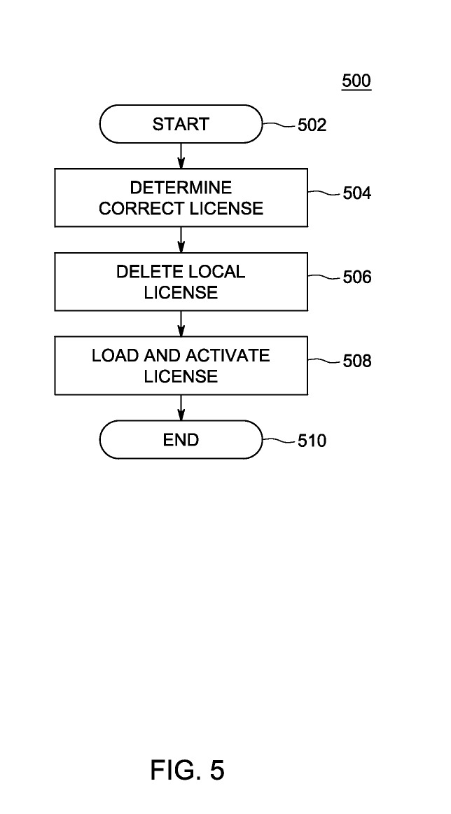

The method 300 proceeds to step 328, where the method 300 facilitates sending the serial number of the dominant subscription product and the product data to the client computer. The method 300 proceeds to step 334, where the method 300 activates a license for the subscription product as described in further detail with respect to FIG. 5 below. The method 300 proceeds to step 336 and ends.

FIG. 4 depicts a flow diagram of a method 400 for validating a redemption code, as performed by the redemption code validation module 150 of FIG. 1, according to one or more embodiments. The method 400 ensures the purchased product was indeed sold, has not already been redeemed and was sold in an intended geographic sales region. The method 400 starts at step 402 and proceeds to step 404.

At step 404, the method 400 retrieves the triple containing the redemption code from a triples database. The redemption code is used as an index to retrieve the triple. The triple contains a VIN, the redemption code, and a serial number for the purchased product. The method 400 proceeds to step 406, where the method 400 evaluates the state of the VIN in the retrieved triple. If the state of the VIN is not “SOLD”, the redemption code was misappropriated and the method 400 proceeds to step 416. However, if the state of the VIN is “SOLD”, the method 400 proceeds to step 408. At step 408, the method 400 evaluates the state of the redemption code in the retrieved triple. If the state of the redemption code is “REDEEMED”, the redemption code has already been used to activate a subscription and the method 400 proceeds to step 416.

However, if the state of the redemption code is “NOT REDEEMED”, the method 400 proceeds to step 410, where the method 400 retrieves a user profile associated with the purchaser. The user profile contains a country code for the user. The method 400 proceeds to step 412, where the method 400 determines whether the sales region where the subscription product was sold is valid. The method 400 compares a country code found in the user profile to a sales region associated with the sold subscription product. The sales region where the subscription product was sold in contained in the VIN. The method 400 looks up the sales region from the sold subscription product in a sales region map. If the country code found in the user profile is not mapped to the sales region where the software subscription product was sold, the sales region is invalid. An invalid sales region typically means a software subscription product was purchased in a lower priced geographic region and then resold in a higher priced geographic region by an unauthorized vendor. If the sales region is invalid, the method 400 proceeds to step 416. At step 416, the method 400 returns INVALID. The method 400 proceeds to step 420 and ends.

However, if at step 412, the country code found in the user profile is mapped to the sales region where the software subscription product was sold, the method 400 determines the sales region is valid and proceeds to step 414, where the method 400 returns VALID. The method 400 proceeds to step 418, where the method 400 updates a state of the redemption code to “REDEEMED” and proceeds to step 420 and ends.

FIG. 5 depicts a flow diagram of a method 500 for activating the purchased subscription product as performed by the activation module 132 of FIG. 1, according to one or more embodiments. The method 500 determines an appropriate license for the purchased subscription product and activates the license so the purchaser may access the subscription product. The purchaser may then load and use the software product on the client computer.

The method 500 starts at step 502 and proceeds to step 504. At step 504, the method 500 determines a correct license that is to be activated for the subscription product. The method 500 looks up a product ID provided in the product data in a product information file. The product ID in the product information file is associated with a license configuration file that is activated to provision the subscription product on the client computer.

The method 500 proceeds to step 506 where the method 500 deletes a local license for the serial number that was received from the subscription server, if one exists. The method 500 proceeds to step 508, where the license configuration file found in the product information file that was associated with the product ID is loaded onto the client computer and the license is activated. The method 500 proceeds to step 510 and ends.

The embodiments of the present invention may be embodied as methods, system, apparatus, electronic devices, and/or computer program products. Accordingly, the embodiments of the present invention may be embodied in hardware and/or in software (including firmware, resident software, micro-code, etc.), which may be generally referred to herein as a “circuit” or “module”. Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device. These computer program instructions may also be stored in a computer-usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium include the following: hard disks, optical storage devices, a transmission media such as those supporting the Internet or an intranet, magnetic storage devices, an electrical connection having one or more wires, a portable computer diskette, a random access memory (RAM), a read-only memory (ROM), an erasable programmable read-only memory (EPROM or Flash memory), an optical fiber, and a compact disc read-only memory (CD-ROM).

Computer program code for carrying out operations of the present invention may be written in an object oriented programming language, such as Java®, Smalltalk or C++, and the like. However, the computer program code for carrying out operations of the present invention may also be written in conventional procedural programming languages, such as the “C” programming language and/or any other lower level assembler languages. It will be further appreciated that the functionality of any or all of the program modules may also be implemented using discrete hardware components, one or more Application Specific Integrated Circuits (ASICs), or programmed Digital Signal Processors or microcontrollers.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present disclosure and its practical applications, to thereby enable others skilled in the art to best utilize the invention and various embodiments with various modifications as may be suited to the particular use contemplated.

### Example Computer System

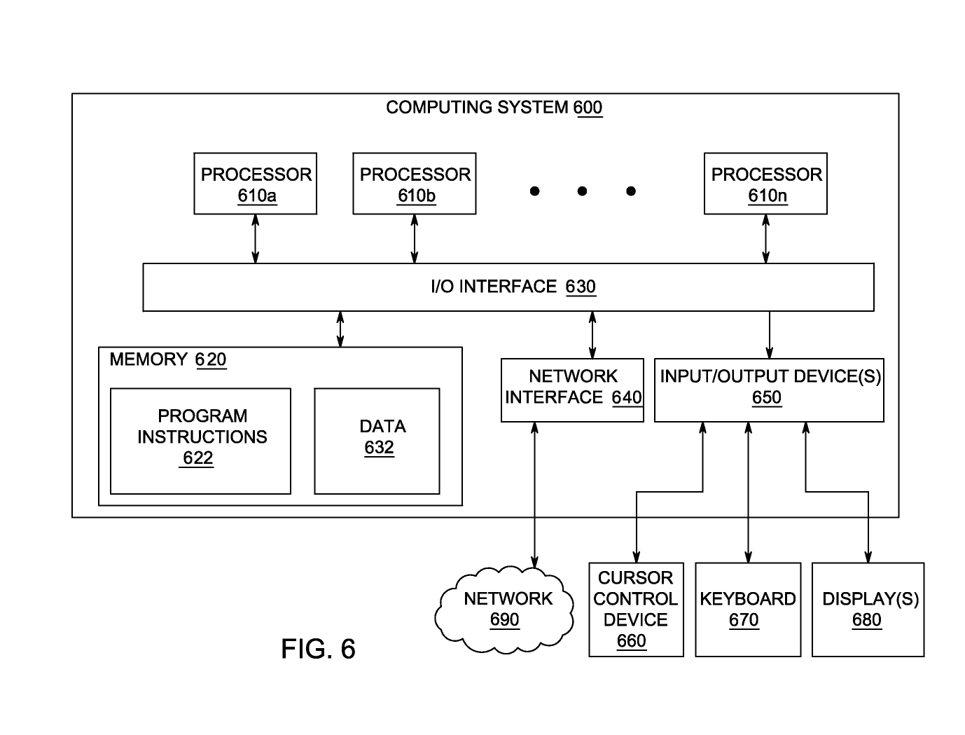

FIG. 6 depicts a computer system that is a computing device and can be utilized in various embodiments of the present invention, according to one or more embodiments.

Various embodiments of a method and apparatus for provisioning price-differentiated products while deterring piracy, as described herein, may be executed on one or more computer systems, which may interact with various other devices. One such computer system is computer system 600 illustrated by FIG. 6, which may in various embodiments implement any of the elements or functionality illustrated in FIGS. 1-5. In various embodiments, computer system 600 may be configured to implement methods described above. The computer system 600 may be used to implement any other system, device, element, functionality or method of the above-described embodiments. In the illustrated embodiments, computer system 600 may be configured to implement methods 200, 300, 400, and 500 as processor-executable executable program instructions 622 (e.g., program instructions executable by processor(s) 610a-n) in various embodiments.

In the illustrated embodiment, computer system 600 includes one or more processors 610a-n coupled to a system memory 620 via an input/output (I/O) interface 630. The computer system 600 further includes a network interface 640 coupled to I/O interface 630, and one or more input/output devices 650, such as cursor control device 660, keyboard 670, and display(s) 680. In various embodiments, any of components may be utilized by the system to receive user input described above. In various embodiments, a user interface (e.g., user interface) may be generated and displayed on display 680. In some cases, it is contemplated that embodiments may be implemented using a single instance of computer system 600, while in other embodiments multiple such systems, or multiple nodes making up computer system 600, may be configured to host different portions or instances of various embodiments. For example, in one embodiment some elements may be implemented via one or more nodes of computer system 600 that are distinct from those nodes implementing other elements. In another example, multiple nodes may implement computer system 600 in a distributed manner.

In different embodiments, computer system 600 may be any of various types of devices, including, but not limited to, a personal computer system, desktop computer, laptop, notebook, or netbook computer, mainframe computer system, handheld computer, workstation, network computer, a camera, a set top box, a mobile device, a consumer device, video game console, handheld video game device, application server, storage device, a peripheral device such as a switch, modem, router, or in general any type of computing or electronic device.

In various embodiments, computer system 600 may be a uniprocessor system including one processor 610, or a multiprocessor system including several processors 610 (e.g., two, four, eight, or another suitable number). Processors 610a-n may be any suitable processor capable of executing instructions. For example, in various embodiments processors 610 may be general-purpose or embedded processors implementing any of a variety of instruction set architectures (ISAs), such as the x96, PowerPC®, SPARC®, or MIPS® ISAs, or any other suitable ISA. In multiprocessor systems, each of processors 610a-n may commonly, but not necessarily, implement the same ISA.

System memory 620 may be configured to store program instructions 622 and/or data 632 accessible by processor 610. In various embodiments, system memory 620 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing any of the elements of the embodiments described above may be stored within system memory 620. In other embodiments, program instructions and/or data may be received, sent or stored upon different types of computer-accessible media or on similar media separate from system memory 620 or computer system 600.

In one embodiment, I/O interface 630 may be configured to coordinate I/O traffic between processor 610, system memory 620, and any peripheral devices in the device, including network interface 640 or other peripheral interfaces, such as input/output devices 650. In some embodiments, I/O interface 630 may perform any necessary protocol, timing or other data transformations to convert data signals from one components (e.g., system memory 620) into a format suitable for use by another component (e.g., processor 610). In some embodiments, I/O interface 630 may include support for devices attached through various types of peripheral buses, such as a variant of the Peripheral Component Interconnect (PCI) bus standard or the Universal Serial Bus (USB) standard, for example. In some embodiments, the function of I/O interface 630 may be split into two or more separate components, such as a north bridge and a south bridge, for example. Also, in some embodiments some or all of the functionality of I/O interface 630, such as an interface to system memory 620, may be incorporated directly into processor 610.

Network interface 640 may be configured to allow data to be exchanged between computer system 600 and other devices attached to a network (e.g., network 690), such as one or more external systems or between nodes of computer system 600. In various embodiments, network 690 may include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 640 may support communication via wired or wireless general data networks, such as any suitable type of Ethernet network, for example; via telecommunications/telephony networks such as analog voice networks or digital fiber communications networks; via storage area networks such as Fiber Channel SANs, or via any other suitable type of network and/or protocol.

Input/output devices 650 may, in some embodiments, include one or more display terminals, keyboards, keypads, touchpads, scanning devices, voice or optical recognition devices, or any other devices suitable for entering or accessing data by one or more computer systems 600. Multiple input/output devices 650 may be present in computer system 600 or may be distributed on various nodes of computer system 600. In some embodiments, similar input/output devices may be separate from computer system 600 and may interact with one or more nodes of computer system 600 through a wired or wireless connection, such as over network interface 640.

In some embodiments, the illustrated computer system may implement any of the methods described above, such as the method illustrated by the flowcharts of FIGS. 2-5. In other embodiments, different elements and data may be included.

Those skilled in the art will appreciate that computer system 600 is merely illustrative and is not intended to limit the scope of embodiments. In particular, the computer system and devices may include any combination of hardware or software that can perform the indicated functions of various embodiments, including computers, network devices, Internet appliances, PDAs, wireless phones, pagers, etc. Computer system 600 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 600 may be transmitted to computer system 600 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium or via a communication medium. In general, a computer-accessible medium may include a storage medium or memory medium such as magnetic or optical media, e.g., disk or DVD/CD-ROM, volatile or non-volatile media such as RAM (e.g., SDRAM, DDR, RDRAM, SRAM, etc.), ROM, etc.

The methods described herein may be implemented in software, hardware, or a combination thereof, in different embodiments. In addition, the order of methods may be changed, and various elements may be added, reordered, combined, omitted, modified, etc. All examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

While the foregoing is directed to embodiments of the present invention, other and further embodiments of the invention may be devised without departing from the basic scope thereof, and the scope thereof is determined by the claims that follow.

1. A computer-implemented method comprising:
creating a plurality of triples, wherein each triple comprises a first component, a second component, and a third component, wherein each triple uniquely identifies a price-differentiated product;
providing to a vendor of the price-differentiated product a plurality of pairs, wherein each pair in the plurality of pairs comprises the first component of the triple and the second component of the triple for each price-differentiated product provided to the vendor;
receiving the pair from the vendor when the price-differentiated product is sold;
providing to a purchaser identification verifier the pair for the price-differentiated product that was sold;
receiving from the purchaser identification verifier the second component of the triple upon verification of an identity of a purchaser; and
providing product activation information to the identity verified purchaser in response to receiving the second component, wherein the activation information enables use of the price-differentiated product.

2. The method of claim 1, wherein verification of an identity confirms the purchaser is a member of a population for which the price-differentiated software product is intended.

3. The method of claim 1, wherein the first component is a vendor identification number and the second component is a redemption code.

4. The method of claim 1, wherein the software product is at least one of a subscription product or a perpetual product.

5. The method of claim 4, wherein the activation code is a serial number, wherein the serial number is the third component of the triple and activates a perpetual product.

6. The method of claim 4, wherein the activation code is a serial number and a plurality of product data, where the serial number is the third component of the triple and the serial number and product data activate a license for a subscription product.

7. The method of claim 1, wherein each triple defines a sales region where the product is intended for sale, and further comprising verifying the product was purchased in the defined sales region before providing the product activation information to the identity verified purchaser.

8. An apparatus comprising:
a product coordination module for creating a plurality of triples, wherein each triple comprises a first component, a second component, and a third component, wherein each triple uniquely identifies a price-differentiated product, providing to a vendor of the product a plurality of pairs, wherein each pair in the plurality of pairs comprises the first component of the triple and the second component of the triple for each price-differentiated product provided to the vendor, receiving the pair from the vendor when the product is sold, and providing to a purchaser identification verifier the pair for the product that was sold; and
a redemption code validation module for receiving from the purchaser identification verifier the second component of the triple upon verification of an identity of a purchaser and providing product activation information to the identity verified purchaser in response to receiving the second component, wherein the activation information enables use of the product.

9. The apparatus of claim 8, wherein the first component is a vendor identification number and the second component is a redemption code.

10. The apparatus of claim 8, wherein the software product is at least one of a subscription product or a perpetual product.

11. The apparatus of claim 10, wherein the activation code is a serial number, wherein the serial number is the third component of the triple and activates a perpetual product.

12. The apparatus of claim 10, wherein the activation code is a serial number and a plurality of product data, where the serial number is the third component of the triple and the serial number and product data activate a license for a subscription product.

13. The apparatus of claim 8, wherein the redemption code validation module further verifies the software product was purchased in a sales region where the software product is intended for sale.

14. A non-transient computer readable medium for storing computer instructions that, when executed by at least one processor cause the at least one processor to perform a method of provisioning a price-differentiated product while deterring piracy comprising:
creating a plurality of triples, wherein each triple comprises a first component, a second component, and a third component, wherein each triple uniquely identifies a price-differentiated product;
providing to a vendor of the product a plurality of pairs, wherein each pair in the plurality of pairs comprises the first component of the triple and the second component of the triple for each price-differentiated product provided to the vendor;
receiving the pair from the vendor when the product is sold;
providing to a purchaser identification verifier the pair for the product that was sold;
receiving from the purchaser identification verifier the second component of the triple upon verification of an identity of a purchaser; and
providing product activation information to the identity verified purchaser in response to receiving the second component, wherein the activation information enables use of the product.

15. The computer readable medium of claim 14, wherein verification of an identity confirms the purchaser is a member of a population for which the price-differentiated software product is intended.

16. The computer readable medium of claim 14, wherein the first component is a vendor identification number and the second component is a redemption code.

17. The computer readable medium of claim 14, wherein the software product is at least one of a subscription product or a perpetual product.

18. The computer readable medium of claim 17, wherein the activation code is a serial number, wherein the serial number is the third component of the triple and activates a perpetual product.

19. The computer readable medium of claim 17, wherein the activation code is a serial number and a plurality of product data, where the serial number is the third component of the triple and the serial number and product data activate a license for a subscription product.

20. The computer readable medium of claim 14, wherein each triple defines a sales region where the product is intended for sale, and further comprising verifying the product was purchased in the defined sales region before providing the product activation information to the identity verified purchaser.
